(19) United States
(12) Patent Application Publication
(10) Pub. No.: US 2025/0363513 A1
(43) Pub. Date: Nov. 27, 2025

(54) METHODS, SYSTEMS, APPARATUSES, AND DEVICES FOR FACILITATING DETERMINING PRICES OF PRODUCTS

(71) Applicant: Alfonso Vazquez Elvira, Las Rozas (ES)

(72) Inventor: Alfonso Vazquez Elvira, Las Rozas (ES)

(21) Appl. No.: 18/673,548

(22) Filed: May 24, 2024

(51) Int. Cl. G06Q 30/0201; G06Q 30/0202

(52) U.S. Cl. CPC G06Q 30/0206; G06Q 30/0202

(57) ABSTRACT

A method of determining prices of products. Further, the method includes receiving, using a quantum processing device, price elasticity values associated with price points. Further, the price elasticity values correspond to products. Further, the method includes receiving, using the quantum processing device, cross-elasticity values associated with related product price points. Further, the cross-elasticity values correspond to a pair of products comprising a target product and a related product. Further, the method includes formulating, using the quantum processing device, an objective function based on all possible combinations of the price elasticity values and the cross-elasticity values. Further, the method includes performing, using the quantum processing device, a quantum optimization of the objective function. Further, the method includes determining, using the quantum processing device, an optimal combination of prices corresponding to maximizing a total volume and a total margin corresponding to sales of the products based on the quantum optimization.

### FIELD OF THE INVENTION

Generally, the present disclosure relates to the field of data processing. More specifically, the present disclosure relates to methods, systems, apparatuses, and devices for facilitating determining prices of products.

### BACKGROUND OF THE INVENTION

Organizations (such as companies, businesses, etc.) selling products need to optimize the prices of the products such that their profits are maximized. Further, organizations need to consider different combinations of price elasticities and cross price elasticities to optimize the prices. Historical approaches with traditional computers do not allow to evaluate of all the possible combinations of cross elasticities. For example, if a company has 50 products that have some cross elasticities between each other and differ per region, per retailer, etc., and then that company has cross elasticities with competing products, then the number of possible combinations can be easily above 10 to the power of 67 every month. Therefore, traditional computers use some mathematical exploration approaches that find decent optimization but they cannot evaluate all the combinations. Further, the current solutions with traditional computers are not able to evaluate all possible scenarios and do not guarantee the finding of the optimal combination of prices and take a lot of processing and/or computing time and resource.

Therefore, there is a need for improved methods, systems, apparatuses, and devices for facilitating determining prices of products that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of determining prices of products, in accordance with some embodiments. Accordingly, the method may include a step of receiving, using a quantum processing device, a plurality of price elasticity values associated with a plurality of price points. Further, the plurality of price elasticity values corresponds to a plurality of products. Further, a price elasticity value may include at least one of a predicted volume and a predicted margin corresponding to a price point. Further, the method may include a step of receiving, using the quantum processing device, a plurality of cross-elasticity values associated with a plurality of related product price points. Further, the plurality of cross-elasticity values corresponds to at least one pair of products comprising a target product and a related product. Further, a cross-elasticity value of the target product may include at least one of a predicted volume and a predicted margin corresponding to a related product price point. Further, the method may include a step of formulating, using the quantum processing device, an objective function based on all possible combinations of the plurality of price elasticity values and the plurality of cross-elasticity values. Further, the method may include a step of performing, using the quantum processing device, a quantum optimization of the objective function. Further, the method may include a step of determining, using the quantum processing device, an optimal combination of prices corresponding to maximizing at least one of a total volume and a total margin corresponding to sales of the plurality of products based on the quantum optimization.

Further disclosed herein is a method of determining prices of products, in accordance with some embodiments. Accordingly, the method may include a step of receiving, using a quantum processing device, a plurality of price elasticity values associated with a plurality of price points. Further, the plurality of price elasticity values corresponds to a plurality of products. Further, a price elasticity value may include at least one of a predicted volume and a predicted margin corresponding to a price point. Further, the method may include a step of receiving, using the quantum processing device, a plurality of cross-elasticity values associated with a plurality of related product price points. Further, the plurality of cross-elasticity values corresponds to at least one pair of products comprising a target product and a related product. Further, a cross-elasticity value of the target product may include at least one of a predicted volume and a predicted margin corresponding to a related product price point. Further, the method may include a step of formulating, using the quantum processing device, an objective function based on all possible combinations of the plurality of price elasticity values and the plurality of cross-elasticity values. Further, the method may include a step of encoding, using the quantum processing device, the objective function based on at least one of a spin model and a Hamiltonian. Further, the method may include a step of performing, using the quantum processing device, a quantum optimization of the objective function based on the encoding. Further, the method may include a step of determining, using the quantum processing device, an optimal combination of prices corresponding to maximizing at least one of a total volume and a total margin corresponding to sales of the plurality of products based on the quantum optimization.

Further disclosed herein is a quantum processing system for determining prices of products, in accordance with some embodiments. Accordingly, the quantum processing system may include a quantum processing device. Further, the quantum processing device may be configured for receiving a plurality of price elasticity values associated with a plurality of price points. Further, the plurality of price elasticity values corresponds to a plurality of products. Further, a price elasticity value may include at least one of a predicted volume and a predicted margin corresponding to a price point. Further, the quantum processing device may be configured for receiving a plurality of cross-elasticity values associated with a plurality of related product price points. Further, the plurality of cross-elasticity values corresponds to at least one pair of products comprising a target product and a related product. Further, a cross-elasticity value of the target product may include at least one of a predicted volume and a predicted margin corresponding to a related product price point. Further, the quantum processing device may be configured for formulating an objective function based on all possible combinations of the plurality of price elasticity values and the plurality of cross-elasticity values. Further, the quantum processing device may be configured for performing a quantum optimization of the objective function. Further, the quantum processing device may be configured for determining an optimal combination of prices corresponding to maximizing at least one of a total volume and a total margin corresponding to sales of the plurality of products based on the quantum optimization.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flowchart of a method 200 of determining prices of products, in accordance with some embodiments.

FIG. 3 is a flowchart of a method 300 of determining the prices of the products, in accordance with some embodiments.

FIG. 4 is a flowchart of a method 400 of determining prices of products, in accordance with some embodiments.

FIG. 5 is a block diagram of a quantum processing system 500 for determining prices of products, in accordance with some embodiments.

FIG. 6 is a block diagram of the quantum processing system 500, in accordance with some embodiments.

FIG. 7 is a block diagram of the quantum processing system 500, in accordance with some embodiments.

FIG. 8 is a representation 800 of a predictive elasticity of a plurality of products corresponding to a plurality of price points of the plurality of products, in accordance with some embodiments.

FIG. 9 is a graphical representation 900 of a predictive elasticity of a product corresponding to a plurality of price points of the products, in accordance with an exemplary embodiment.

FIG. 10 is a representation 1000 of a predictive cross elasticity of a plurality of related products corresponding to a plurality of price points of the plurality of related products, in accordance with some embodiments.

FIG. 11 is a graphical representation 1100 of a predictive cross elasticity of a pair of related products corresponding to a plurality of price points of one of the pair of related products, in accordance with an exemplary embodiment.

FIG. 12 is a tabular representation 1200 of combination alternatives of a plurality of price points of a plurality of products, margin and cross elasticities value corresponding to the combination alternatives, margin per product with the cross elasticities, and total margin, in accordance with some embodiments.

FIG. 13 is a continuation of the tabular representation 1200, in accordance with some embodiments.

FIG. 14 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating determining prices of products, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g.

the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods, systems, apparatuses, and devices for determining prices of products.

Further, the present disclosure describes a quantum algorithm which when given margin of sales at each price point (per product) and cross effects of sales effects that correspond to changes in prices of each product change (i.e. how they affect the other product) finds the combinations of prices for each product, region, retailer, or time period that maximize total margin and/or total volume. Further, the quantum algorithm which is based on quantum technology is able to evaluate way more scenarios, even all of them: thus giving better margin and volume for the company selling these products.

Further, the present disclosure describes creation of quantum algorithms for solving price-demand optimization problems of consumer goods. Further, the quantum algorithms are for fast-moving consumer goods price optimization.

Further, the present disclosure describes optimizing the price combinations of the products to maximize either total margin or total volume by combining the predictor values of price elasticities with the estimate of cross-elasticities between the “target” product and other “related” products for creating a relationship between the price of the target product and profits/margins in sales over a given period in a given store, a distribution channel, a retailer, a region, or a country.

Further, the present disclosure describes a quantum optimization for an objective function that admits a simple formulation in terms of a spin model or equivalent Hamiltonian. Further, the quantum optimizing involves applying purely quantum optimization techniques like “annealing”.

Further, the present disclosure describes a hybrid optimization with classical-quantum algorithms for an objective function that is particularly complex. Further, the hybrid optimization involves employing hybrid techniques where evaluation or optimization can be delegated to a classical computer, using the quantum computer in other stages.

Further, the present disclosure describes utilization of quantum integer programming (QIP) to address the objective of maximizing margin by considering all possible combinations of elasticities and cross elasticities. Further, the QIP offers the advantage of providing an exact solution, ensuring the achievement of the highest possible margin. Additionally, when implemented on fault-tolerant quantum computers with quantum error correction techniques, QIP surpasses the accuracy of algorithms on noisy intermediate-scale quantum (NISQ) devices, including a quantum approximate optimization algorithm (QAOA). Further, the QIP may handle various types of constraints and objective functions and may exploit the quantum speedup offered by Grover's algorithm and its variants. Further, the QIP may also be combined with classical heuristics and hybrid methods to enhance the performance and scalability of the solution process.

Further, the present disclosure describes using QIP to model the problem of maximizing margin as a quadratic unconstrained binary optimization (QUBO) problem. A QUBO problem is a special case of QIP where the variables are binary (0 or 1) and the objective function is quadratic. QUBO problems may easily be mapped to Ising models, which may be the natural input for quantum annealing devices such as D-Wave. For formulating the problem as a QUBO problem, the elasticities and cross-elasticities need to be encoded as binary variables and the margin function needs to be expressed as a quadratic polynomial of these variables. The coefficients of the quadratic polynomial will depend on the parameters of the problem, such as the prices, costs, and demand functions of the products. The goal is to find the optimal combination of binary variables that maximizes the margin function. Further, the use of the QIP guarantees an exact solution, ensuring the achievement of the maximum margin from all possible combinations. Further, the use of quantum computing allows for efficient exploration of vast solution spaces, which is particularly valuable for complex optimization problems. Further, the QIP is implemented on fault-tolerant quantum computers with quantum error correction techniques for ensuring high precision and reliability. Further, the QIP offers flexibility and optimization by tailoring to the specific requirements of the problem.

Further, the present disclosure describes the implementation of quantum integer programming (QIP) for exact margin maximization. Further, the implementation of the QIP for the exact margin maximization may include problem formulation which includes defining the problem rigorously, including the optimization objective, constraints, and the relevant elasticities and cross elasticities. Further, the implementation of the QIP for the exact margin maximization may include quantum encoding which includes encoding the problem into a quantum format suitable for quantum computation. Further, the implementation of the QIP for the exact margin maximization may include quantum integer programming which includes utilizing QIP to solve the problem optimally, ensuring that all possible combinations are considered. Further, the implementation of the QIP for the exact margin maximization may include quantum circuit depth optimization which includes fine-tuning the quantum circuit's depth to balance computational resources and accuracy. Further, the implementation of the QIP for the exact margin maximization may include fault-tolerant quantum computing which includes implementing the QIP algorithm on a fault-tolerant quantum computer with quantum error correction for precise results.

Further, the present disclosure describes a method for exact margin maximization. Further, a first step of the method may include defining the price prediction problem that is required to be solved, such as predicting the optimal price of a product that maximizes the profit or revenue and identifying the decision variables, the objective function, and the constraints of the problem. For example, the decision variable may be the price of the product, the objective function may be the profit or revenue function, and the constraints could be the demand function, the cost function, or the market conditions. Further, a second step of the method may include encoding the decision variables as binary variables, using techniques such as binary expansion, one-hot encoding, or logical encoding. Further, a third step of the method may include expressing the objective function and the constraints as quadratic polynomials of the binary variables. Further, the objective function may be a Profit=(P·Q)−(C·Q)−F, where P is the price of the product, Q is the quantity sold at price P, C is the cost of production per unit, and F is a fixed cost (such as overheads, marketing, etc.). Further, a fourth step of the method may include formulating the problem as a quadratic unconstrained binary optimization (QUBO) problem by combining the objective function and the constraints into a single quadratic polynomial. The goal is to find the optimal combination of binary variables that maximizes the QUBO polynomial. Further, a fifth step of the method may include choosing a quantum algorithm and a quantum device for solving the QUBO problem. Some of the possible options are Quantum Annealing (QA), Quantum Approximate Optimization Algorithm (QAOA), or Quantum Alternating Operator Ansatz (QAOA). Each algorithm has its own advantages and disadvantages in terms of performance, scalability, and accuracy. Further, a sixth step of the method may include running the quantum algorithm on the quantum device and obtaining the output state. The output state is a superposition of all possible combinations of binary variables, with different amplitudes corresponding to different values of the QUBO polynomial. Further, a seventh step of the method may include measuring the output state and decoding the optimal combination of binary variables. Further, the seventh step needs to be repeated multiple times to increase the probability of obtaining the correct solution. Further, error correction or mitigation techniques are required to be applied to reduce the effects of noise and decoherence on the quantum device. Further, an eighth step of the method may include interpreting the optimal combination of binary variables and translating the optimal combination of the binary variables back to the original decision variable. Further, the profit or revenue function at this optimal price may be evaluated and verified that the profit or revenue function satisfies the problem requirements.

Further, the present disclosure describes a pseudo algorithm for margin optimization with cross-product elasticity. Further, the pseudo algorithm may include the following steps:
Initialize Parameters: Set the initial margin value (initial_margin), and define any other relevant parameters specific to your problem.
Define Qubit Encoding: Determine the number of qubits needed to be encoded product prices (n) and margin (m).
Create Quantum Register: Initialize a quantum register (qr) to hold the qubits needed for computation.
Create Classical Register: Initialize a classical register (cr) to hold the classical measurement outcomes.
Create Quantum Circuit: Set up a quantum circuit (qc) using the quantum and classical registers.
Define Log-Normal Distribution for Margin: Create a log-normal distribution for the margin values. This models the uncertainty in margin due to factors like cross-product elasticity.
Encode Margin into Quantum State: Use the log-normal distribution to encode margin values into the quantum state using the In_dist.build(qc, qr) function.
Define Margin Calculation Function: Define a function (margin(x)) that computes the margin based on product prices and cross-product elasticity.
Define Binary Representation Function: Define a function (binary_repr(x)) to convert margin values to a binary representation.
Define Conditional Rotation Function: Define a function (conditional_rotation(qc, qr, x)) to apply conditional rotation gates based on the calculated margin.
Apply Conditional Rotations: Iterate over all possible product price states. For each state, calculate the margin, convert it to binary, and apply conditional rotations using the defined functions.
Measure Margin Qubits: Measure the qubits representing the margin.
Create Amplitude Estimation Instance: Set up an instance of Amplitude Estimation with appropriate parameters, specifying the quantum circuit, the objective qubit index, and IQFT (Inverse Quantum Fourier Transform) options.
Run Amplitude Estimation: Execute the amplitude estimation on a quantum simulator, and obtain the estimation result.
Retrieve and Display Results: Print the estimated margin value and the corresponding probability.

Further, the present disclosure describes pseudocode for margin optimization. Further, the pseudocode is as follows:

from qiskit import QuantumRegister, ClassicalRegister, QuantumCircuit,
Aer
from qiskit.aqua.algorithms import AmplitudeEstimation
from qiskit.aqua.components.uncertainty_models import
LogNormalDistribution
import numpy as np
# Define the parameters for margin optimization
initial_margin = 0.1 # Initial margin value
# Add any other relevant parameters specific to your problem
# Define the number of qubits for encoding
n =5 #Numberof qubits for the product prices
m=2 #Numberofqubits for the payoff (margin)
# Create a quantum register
qr = QuantumRegister(n + m)
cr = ClassicalRegister(n + m)
qc = QuantumCircuit(qr, cr)
# Create a log-normal distribution for the product prices
ln_dist = LogNormalDistribution(n, mu=(np.log(initial_margin)),
sigma=0.1,
bounds=(0, None))
# Encode the distribution into the quantum state
qc += ln_dist.build(qc, qr)
# Define a function to compute the margin with cross effects
def margin(prices):
total_margin = np.log(initial_margin) # Initial margin
for i in range(n):
total_margin += prices[i]
for j in range(n):
if i != j:
total_margin += cross_effects[i][j] * prices[i] * prices[j]
return np.exp(total_margin)
# Define a function to map the margin to a binary representation
def binary_repr(x):
return format(int(x), ‘0’+str(m)+‘b’)
# Define a function to apply a conditional rotation based on the margin
def conditional_rotation(qc, qr, prices):
theta = 2 * np.arcsin(np.sqrt(margin(prices) / initial_margin))
b =binary_repr(margin(prices))
for i in range(m):
if b[i] == ‘1’:
qc.cry(theta, qr[n+i], qr[n+m−1−i])
# Define the cross effects matrix
cross_effects = np.array([[0.0, 0.1, 0.2, 0.0, 0.0],
[0.1, 0.0, 0.0, 0.0, 0.0],
[0.2, 0.0, 0.0, 0.1, 0.0],
[0.0, 0.0, 0.1, 0.0, 0.0],
[0.0, 0.0, 0.0, 0.0, 0.0]]) # Modify as needed
# Apply conditional rotations for all possible product prices
for i in range(2**n):
prices = ln_dist.value_to_estimation(i)
conditional_rotation(qc, qr, prices)
# Measure the margin qubits
qc.measure(qr[n:n+m], cr[n:n+m])
# Create an amplitude estimation instance with the quantum circuit.
ae = AmplitudeEstimation(3, circuit=qc, i_objective=n+m−1, iqft=None)
# Run the amplitude estimation on a simulator and print the result
backend = Aer.get_backend(‘qasm_simulator’)
result = ae.run(backend)
print(‘Estimated margin: %.4f’ % result[‘estimation’])
print(‘Probability: %.4f’ % result[‘max_probability’])

Further, the implementation of the pseudocode is associated with the following steps:
1. Import necessary libraries: The code begins by importing the necessary libraries-cirq for quantum circuit simulation, tensorflow for optimization, and numpy for numerical operations.
2. Define the problem: The problem needs to be represented as a Hamiltonian that can be minimized. This Hamiltonian should be a sum of Pauli operators. Each term in the sum represents a part of the problem.
3. Create a QAS circuit: A function create_qas_circuit(params) is defined to create a quantum approximate optimization scheme (QAS) circuit. This function takes in parameters for single-qubit rotations and creates a circuit with these rotations and additional CZ gates for entanglement.
4. Define the cost function: The cost function cost_function(params) is defined to evaluate the cost of a given set of parameters. It creates a QAS circuit with these parameters, simulates the circuit to sample from the quantum state, and computes an expectation value based on these samples.
5. Implement expectation computation: A function compute_expectation(samples) is defined to compute the expectation value from the sampled data. This function needs to be implemented according to your specific problem.
6. Optimize the parameters: The code initializes some parameters and an optimizer. It then enters a loop where it uses gradient descent to optimize the parameters based on the cost function.

Further, the implementation of the pseudocode is associated with the following requirements:
1. For m decision variables, m*n qubits are needed to represent these variables.
2. An additional p qubits to encode the objective function.
3. Allocation of additional qubits for ancillary purposes, such as intermediate calculations and quantum gates. Further, the allocation of the additional qubits includes, when dealing with quantum optimization, mapping of the objective function onto a quantum circuit. Further, the objective function is mapped to the quantum circuit by mapping variables to qubits. Further, the mapping of the variables to the qubits involves assigning qubits to represent the decision variable(s). In this case, a single qubit is used to represent xx. The qubit state |0 [symbol] |0 [symbol] corresponds to one value of xx, and |1 [symbol] |1 [symbol] corresponds to another value of xx. Further, the mapping of the variables to the qubits involves encoding the quadratic function f(x)f(x) as a quantum circuit. For example, applying a Hadamard gate to create a superposition of states:

$$\vert 0 〉 \to \frac{1}{\sqrt{2}} ( \vert 0 〉 + \vert 0 〉 ) .$$

Further, the allocation of the additional qubits includes applying a phase oracle (unitary operator) that encodes the function. For example, the Oracle will add a phase to the |1 [symbol] |1 [symbol] state based on the value of the function: Oracle: |0 [symbol] →|0 [symbol] , |1 [symbol] →eⁱ⁰|1 [symbol] . Further, the allocation of the additional qubits includes applying additional gates as needed to complete the quantum circuit

Further, the quantum integer programming (QIP) represents a robust solution for the margin maximization task, guaranteeing an exact solution while considering all potential combinations of elasticities and cross elasticities. Its ability to leverage quantum computing advantages and fault-tolerant implementation makes it an ideal choice for achieving the highest level of accuracy.

Further, the present disclosure describes margin optimization. Further, for margin optimization a hybrid quantum algorithm is used. Further, a code associated with the hybrid quantum algorithm includes an Ising Hamiltonian for the mathematical representation of the problem statement, a quantum circuit for creating a superposition of all the states, applying the Ising Hamiltonian to the superposition of states for encoding the optimization problem, and using a simulator to find the highest probability which is chosen as the optimized volume for a given product.

Further, the code uses a dataset of sales of different products each month. This also includes the number of units sold and per unit price for each month. Taking values from this dataset, the optimized result from the code is obtained.

Further, the code is as follows:

import numpy as np
from qiskit import QuantumCircuit, execute, Aer
# Define the data (can be replaced with actual data)
data = np.array([
[100, 20],
[150, 30],
[80, 25],
[120, 35]
])
# Define the Ising Hamiltonian (convert the optimization problem)
num_assets = len(data)
qubit_op = np.zeros((num_assets, num_assets))
# Calculating the Ising Hamiltonian
for i in range(num_assets):
for j in range(num_assets):
if i != j:
qubit_op[i, j] = 2 * data[i, 0] * data[j, 0]
# Initialize a quantum circuit
num_qubits = num_assets
qc = QuantumCircuit(num_qubits, num_qubits)
# Create a superposition of all possible states
qc.h(range(num_qubits))
# Apply the Ising Hamiltonian
for i in range(num_assets):
for j in range(num_assets):
if i != j:
qc.cx(i, j)
qc.rz(qubit_op[i, j], j)
qc.cx(i, j)
# Measure the qubits
qc.measure(range(num_qubits), range(num_qubits))
# Simulate the quantum circuit
simulator = Aer.get_backend(‘qasm_simulator’)
job = execute(qc, simulator, shots=1024)
result = job.result( )
counts = result.get_counts(qc)
# Find the most probable solution
max_count = max(counts, key=counts.get)
optimized_volume = np.array([int(bit) for bit in max_count])
# Print the optimized volume
print(“Optimized Volume for Each Product:”)
for i, volume in enumerate(optimized_volume):
print(f“Product {i+1}: {volume}”)

Further, the values are given in the form of an array:

$$data = np . array ( [ [ 100 , 20 ] , [ 150 , 30 ] , [ 80 , 25 ] , [ 120 , 35 ] ] ) ;$$

the first column is for the number of units sold and the second column is the price per unit for a single product

Further, the values obtained from the code are the optimal amount of each product that needs to be produced in order to get maximum profit. In simulation, the circuit would be given various distributions out of which it is intended to find the expectation value for the maximum value of the state which would return us the most optimal value. Further, the code is intended to be implemented for month on month elasticity and used for finding total volume for maximizing the margin.

Further, the code is intended to be able to handle complex datasets and provide optimization results with the complex datasets using a quantum algorithm. Further, the complex database is used to find the optimal value of the volume of fast-moving products considering month on month elasticity and cross elasticity between two different products.

Further, the present disclosure describes a method of determining prices of products. Further, the method may include receiving, using a quantum processing device, a plurality of values of at least one variable corresponding to a plurality of price points. Further, the plurality of values corresponds to the plurality of products. Further, the method may include receiving, using the quantum processing device, a plurality of cross-effect values of the at least one variable corresponding to a plurality of related product price points. Further, the plurality of cross-effect values corresponds to at least one pair of products comprising a target product and a related product. Further, a cross-effect value of the at least one variable for the target product corresponds to a price point of a related product price point. Further, the method may include formulating, using the quantum processing device, an objective function based on all possible combinations of the plurality of values and the plurality of cross-effect values. Further, the method may include performing, using the quantum processing device, a quantum optimization of the objective function. Further, the method may include determining, using the quantum processing device, an optimal combination of prices corresponding to maximizing the at least one variable corresponding to sales of the plurality of products based on the quantum optimization. Further, the at least one variable may correspond to a decision variable. Further, the at least one variable may include a margin, a volume, a sale quantity, a profit, a demand, a revenue, etc.

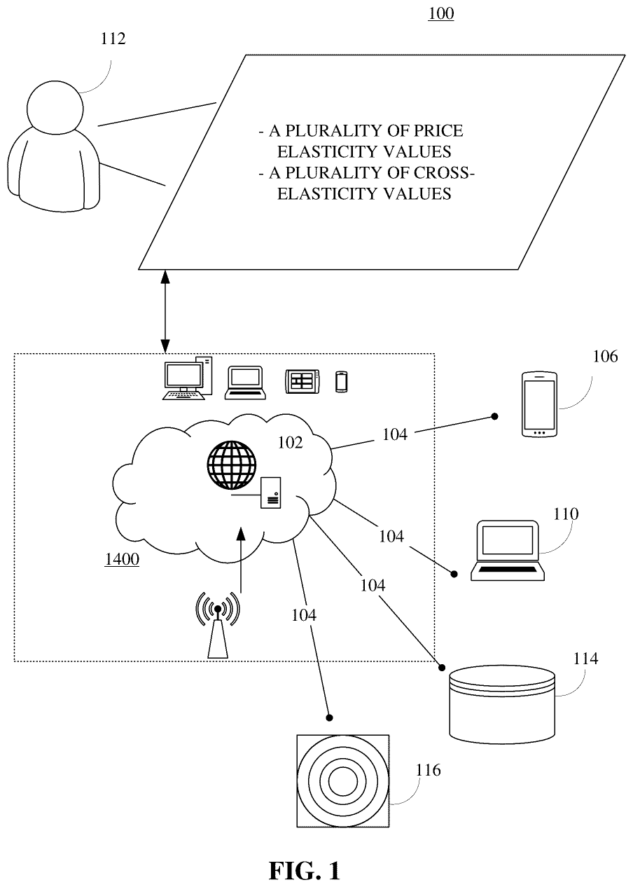

FIG. 1 is an illustration of an online platform 100 consistent with various embodiments of the present disclosure. By way of non-limiting example, the online platform 100 to facilitate determining prices of products may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1400.

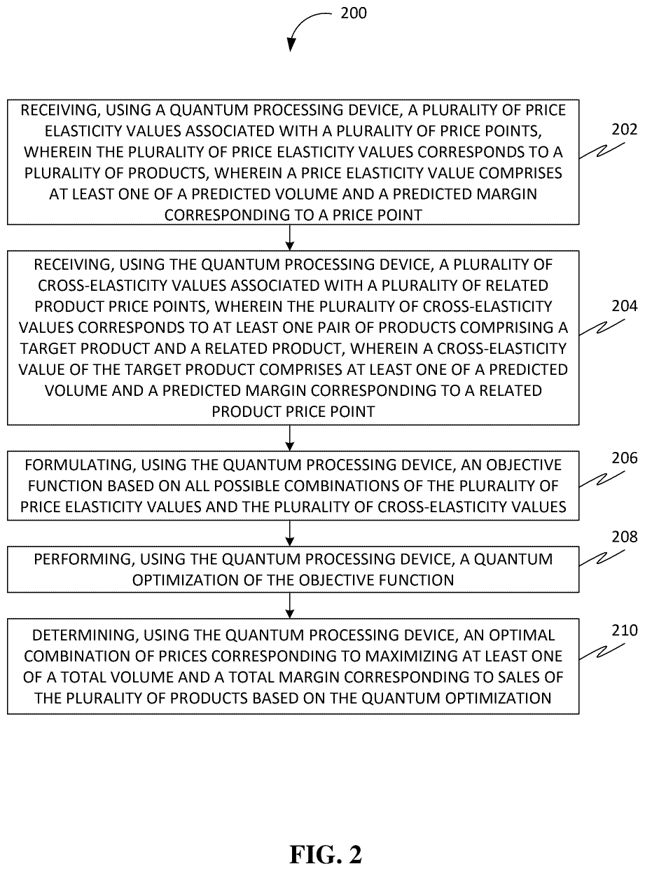

FIG. 2 is a flowchart of a method 200 of determining prices of products, in accordance with some embodiments. Accordingly, at 202, the method 200 may include receiving, using a quantum processing device, a plurality of price elasticity values associated with a plurality of price points. Further, the plurality of price elasticity values corresponds to a plurality of products. Further, a price elasticity value may include at least one of a predicted volume and a predicted margin corresponding to a price point. Further, the plurality of products may include a plurality of goods associated with a plurality of retailers, a plurality of e-commerce, etc. Further, the plurality of products may include a plurality of digital goods. Further, the plurality of digital goods may include software, nonfungible tokens (NFTs), applications, gaming applications, application extensions, application add ons, application updates, application upgrades, etc.

Further, at 204, the method 200 may include receiving, using the quantum processing device, a plurality of cross-elasticity values associated with a plurality of related product price points. Further, the plurality of cross-elasticity values corresponds to at least one pair of products comprising a target product and a related product. Further, a cross-elasticity value of the target product may include at least one of a predicted volume and a predicted margin corresponding to a related product price point.

Further, at 206, the method 200 may include formulating, using the quantum processing device, an objective function based on all possible combinations of the plurality of price elasticity values and the plurality of cross-elasticity values. Further, the objective function may include a margin function, a profit function, a revenue function, etc. Further, the objective function may be used for finding a combination of prices for maximizing the total margin. Further, the objective function may be associated with a problem of maximizing margin, a problem of price prediction, an optimization problem, etc. Further, the quantum processing device may include the objective function. Further, the objective function may include Hamiltonian, likelihood functions, etc. Further, the Hamiltonian may be a function that describes the total energy of the system. Further, the likelihood functions may be utilized in quantum machine learning and quantum statistical inference. Further, the likelihood functions may be associated with a plurality of likelihood function types. Further, the plurality of likelihood function types may include Quantum State Tomography, Quantum Process Tomography, Parameter Estimation in Quantum Algorithms, Fidelity-Based Likelihoods, etc. Further, the likelihood function of the Quantum State Tomography is formulated based on the probability of obtaining a specific measurement outcome given a quantum state described by density matrix p. Further, the likelihood function of the Quantum Process Tomography is constructed based on how the process maps input states to output states. For the parameter estimation using quantum circuits, such as in the Variational Quantum Eigensolver (VQE) or Quantum Machine Learning (QML) algorithms, the likelihood function typically evaluates the probability of obtaining measurement results given certain parameter settings in the quantum circuit. Further, the likelihood function of the Fidelity-Based Likelihoods is based on fidelity measures, as L(θ)=Fidelity (ψ(θ), ϕ), where ψ(θ) is the state produced by a quantum circuit with parameters θ, and ϕ is the target state. The fidelity measures how close ψ(θ) is to ϕ, often aimed to be maximized.

Further, at 208, the method 200 may include performing, using the quantum processing device, a quantum optimization of the objective function.

Further, at 210, the method 200 may include determining, using the quantum processing device, an optimal combination of prices corresponding to maximizing at least one of a total volume and a total margin corresponding to sales of the plurality of products based on the quantum optimization.

Further, in some embodiments, the quantum processing device may be a quantum computer. Further, the quantum computer may include superconducting quantum computers, trapped ion quantum computers, photonic quantum computers, topological quantum computers, silicon quantum computers, etc.

In further embodiments, the method 200 may include encoding, using the quantum processing device, the objective function based on at least one of a spin model and a Hamiltonian. Further, the performing of the quantum optimizing may be based on the encoding of the objective function. Further, in an embodiment, the Hamiltonian may include Ising Hamiltonian.

Further, in some embodiments, the maximizing of the at least one of the total volume and the total margin corresponds to at least one of a store, a distribution channel, a retailer and a geographical region.

Further, in some embodiments, each of the plurality of price elasticity values and the plurality of cross-elasticity values corresponds to a time period.

Further, in some embodiments, the quantum optimization may include at least one of Quantum Annealing (QA), Quantum Approximate Optimization Algorithm (QAOA), and Quantum Alternating Operator Ansatz (QAOA). Further, the quantum optimizing may include executing at least one quantum algorithm based on the objective function. Further, the at least one quantum algorithm may include at least one of the Quantum Annealing (QA), the Quantum Approximate Optimization Algorithm (QAOA), and the Quantum Alternating Operator Ansatz (QAOA).

Further, in some embodiments, the plurality of price points is limited to 50 price points per product.

Further, in some embodiments, the quantum processing device may include a fault tolerant quantum computer configured to perform quantum error correction.

Further, in some embodiments, the objective function may be formulated as a quadratic unconstrained binary optimization (QUBO) problem based on the formulating.

In an embodiment, the method 200 may include encoding, using the quantum processing device, each of the plurality of price elasticity values and the plurality of cross-elasticity values as a plurality of binary variables. Further, the objective function may be formulated as a quadratic polynomial of the plurality of binary variables based on the encoding. Further, a plurality of coefficients of the quadratic polynomial may be based on at least one of prices, costs, and demand functions of the products.

Further, in an embodiment, the encoding of each of the plurality of price elasticity values and the plurality of cross-elasticity values as the plurality of binary variables may include at least one of a binary expansion, one-hot encoding, and logical encoding.

Further, in some embodiments, the quantum processing device may include a quantum annealing device.

Further, in some embodiments, the objective function may be formulated based on at least one constraint. Further, the at least one constraint may include at least one of a demand function, a cost function, and a market condition.

Further, in some embodiments, the objective function may include a profit equation=(P·Q)−(C·Q)−F. Further, P may be a price of a product. Further, Q may be a quantity sold at price P. Further, C may be a cost of production per unit. Further, F may be a fixed operating cost.

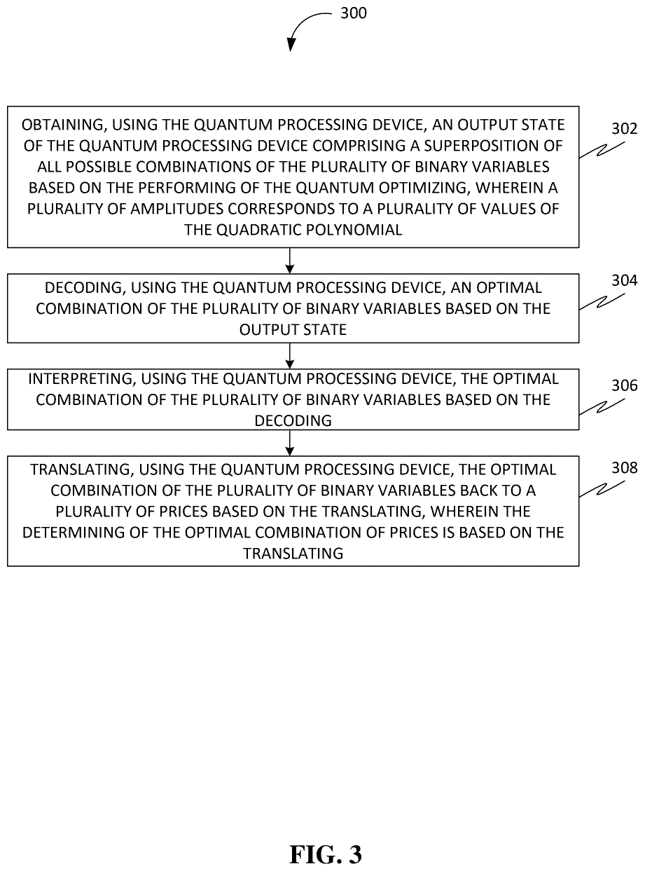

FIG. 3 is a flowchart of a method 300 of determining the prices of the products, in accordance with some embodiments. Accordingly, at 302, the method 300 may include obtaining, using the quantum processing device, an output state of the quantum processing device comprising a superposition of all possible combinations of the plurality of binary variables based on the performing of the quantum optimizing. Further, a plurality of amplitudes corresponds to a plurality of values of the quadratic polynomial.

Further, at 304, the method 300 may include decoding, using the quantum processing device, an optimal combination of the plurality of binary variables based on the output state.

Further, at 306, the method 300 may include interpreting, using the quantum processing device, the optimal combination of the plurality of binary variables based on the decoding.

Further, at 308, the method 300 translating, using the quantum processing device, the optimal combination of the plurality of binary variables back to a plurality of prices based on the translating. Further, the determining of the optimal combination of prices may be based on the translating.

Further, in some embodiments, the step of decoding is performed multiple number of times.

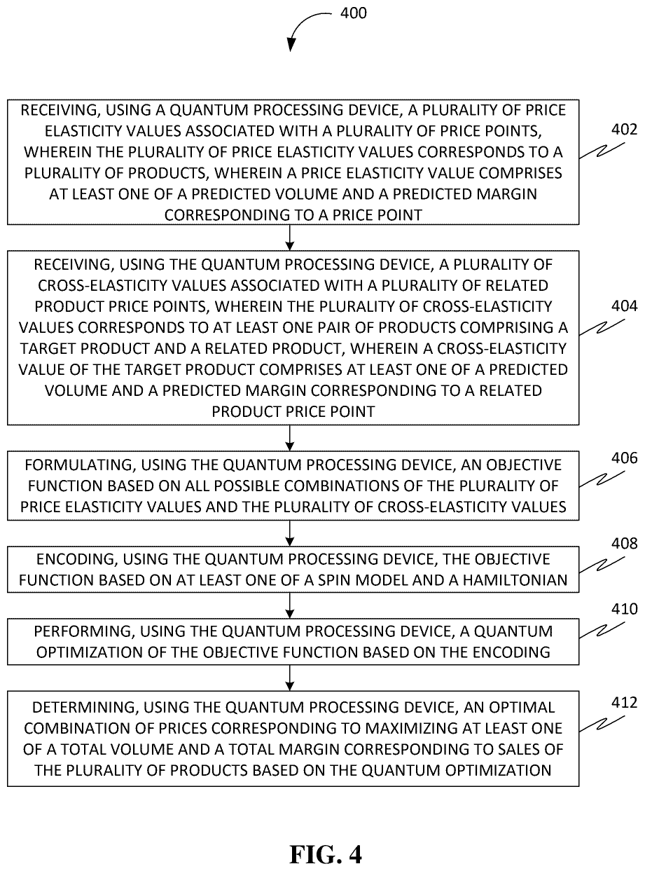

FIG. 4 is a flowchart of a method 400 of determining prices of products, in accordance with some embodiments. Accordingly, at 402, the method 400 may include receiving, using a quantum processing device, a plurality of price elasticity values associated with a plurality of price points. Further, the plurality of price elasticity values corresponds to a plurality of products. Further, a price elasticity value may include at least one of a predicted volume and a predicted margin corresponding to a price point.

Further, at 404, the method 400 may include receiving, using the quantum processing device, a plurality of cross-elasticity values associated with a plurality of related product price points. Further, the plurality of cross-elasticity values corresponds to at least one pair of products comprising a target product and a related product. Further, a cross-elasticity value of the target product may include at least one of a predicted volume and a predicted margin corresponding to a related product price point.

Further, at 406, the method 400 may include formulating, using the quantum processing device, an objective function based on all possible combinations of the plurality of price elasticity values and the plurality of cross-elasticity values.

Further, at 408, the method 400 may include encoding, using the quantum processing device, the objective function based on at least one of a spin model and a Hamiltonian.

Further, at 410, the method 400 may include performing, using the quantum processing device, a quantum optimization of the objective function based on the encoding.

Further, at 412, the method 400 may include determining, using the quantum processing device, an optimal combination of prices corresponding to maximizing at least one of a total volume and a total margin corresponding to sales of the plurality of products based on the quantum optimization.

Further, in some embodiments, the quantum processing device may include a fault tolerant quantum computer configured to perform quantum error correction.

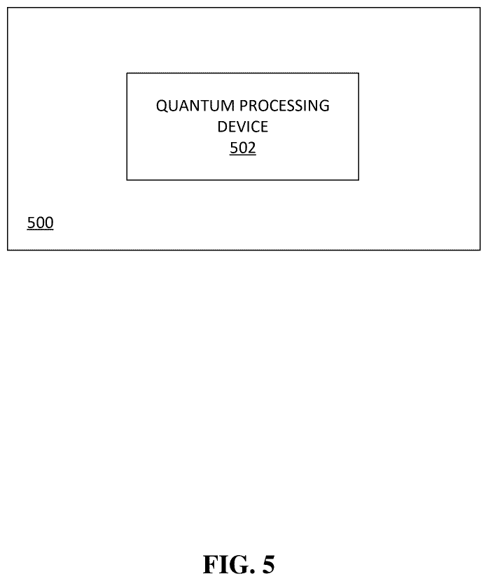

FIG. 5 is a block diagram of a quantum processing system 500 for determining prices of products, in accordance with some embodiments. Accordingly, the quantum processing system 500 may include a quantum processing device 502.

Further, the quantum processing device 502 may be configured for receiving a plurality of price elasticity values associated with a plurality of price points. Further, the plurality of price elasticity values corresponds to a plurality of products. Further, a price elasticity value may include at least one of a predicted volume and a predicted margin corresponding to a price point. Further, the quantum processing device 502 may be configured for receiving a plurality of cross-elasticity values associated with a plurality of related product price points. Further, the plurality of cross-elasticity values corresponds to at least one pair of products comprising a target product and a related product. Further, a cross-elasticity value of the target product may include at least one of a predicted volume and a predicted margin corresponding to a related product price point. Further, the quantum processing device 502 may be configured for formulating an objective function based on all possible combinations of the plurality of price elasticity values and the plurality of cross-elasticity values. Further, the quantum processing device 502 may be configured for performing a quantum optimization of the objective function. Further, the quantum processing device 502 may be configured for determining an optimal combination of prices corresponding to maximizing at least one of a total volume and a total margin corresponding to sales of the plurality of products based on the quantum optimization.

Further, in some embodiments, the quantum processing device 502 may be configured for encoding the objective function based on at least one of a spin model and a Hamiltonian. Further, the performing of the quantum optimizing may be based on the encoding of the objective function.

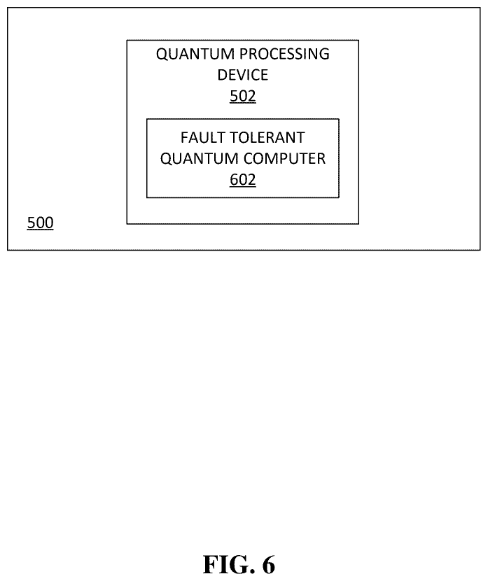

Further, in some embodiments, the quantum processing device 502 may include a fault tolerant quantum computer 602, as shown in FIG. 6, configured to perform quantum error correction.

Further, in some embodiments, the objective function may be formulated as a quadratic unconstrained binary optimization (QUBO) problem.

Further, in an embodiment, the quantum processing device 502 may be configured for encoding each of the plurality of price elasticity values and the plurality of cross-elasticity values as a plurality of binary variables. Further, the objective function may be formulated as a quadratic polynomial of the plurality of binary variables based on the encoding. Further, a plurality of coefficients of the quadratic polynomial may be based on at least one of prices, costs, and demand functions of the plurality of products.

Further, in an embodiment, the quantum processing device 502 may be configured for obtaining an output state of the quantum processing device 502 comprising a superposition of all possible combinations of the plurality of binary variables based on the performing of the quantum optimizing. Further, a plurality of amplitudes corresponds to a plurality of values of the quadratic polynomial. Further, the quantum processing device 502 may be configured for decoding an optimal combination of the plurality of binary variables based on the output state. Further, the quantum processing device 502 may be configured for interpreting the optimal combination of the plurality of binary variables based on the decoding. Further, the quantum processing device 502 may be configured for translating the optimal combination of the plurality of binary variables back to a plurality of prices based on the interpreting. Further, the determining of the optimal combination of prices may be based on the translating.

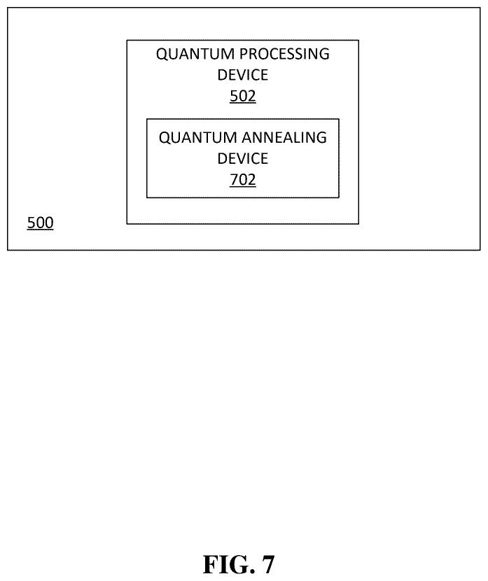

Further, in some embodiments, the quantum processing device 502 may include a quantum annealing device 702, as shown in FIG. 7.

Further, in some embodiments, the objective function may be formulated based on at least one constraint. Further, the at least one constraint may include at least one of a demand function, a cost function, and a market condition.

Further, in some embodiments, the objective function may include a profit equation=(P·Q)−(C·Q)−F. Further, P may be a price of a product. Further, Q may be a quantity sold at price P. Further, C may be a cost of production per unit. Further, F may be a fixed operating cost.

FIG. 6 is a block diagram of the quantum processing system 500, in accordance with some embodiments.

FIG. 7 is a block diagram of the quantum processing system 500, in accordance with some embodiments.

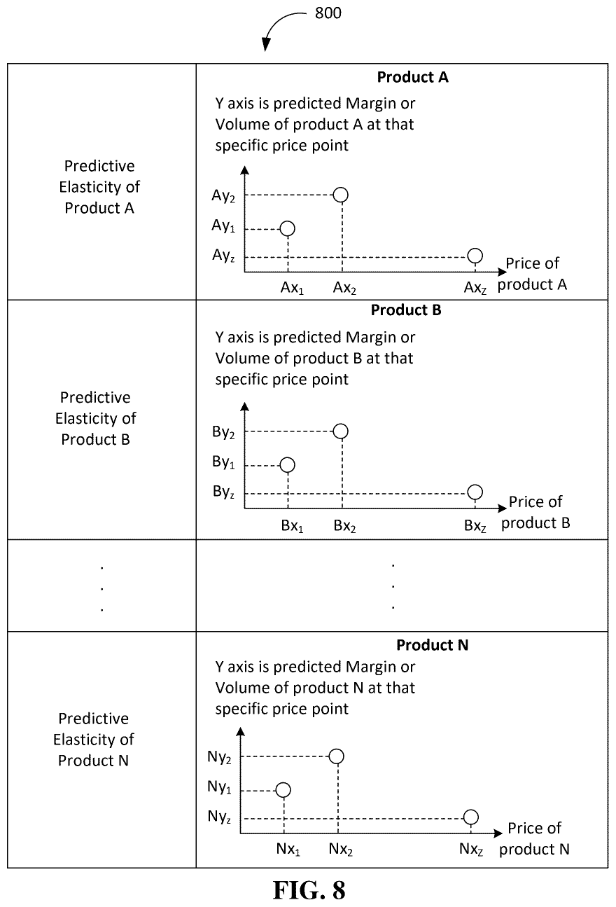

FIG. 8 is a representation 800 of a predictive elasticity of a plurality of products corresponding to a plurality of price points of the plurality of products, in accordance with some embodiments.

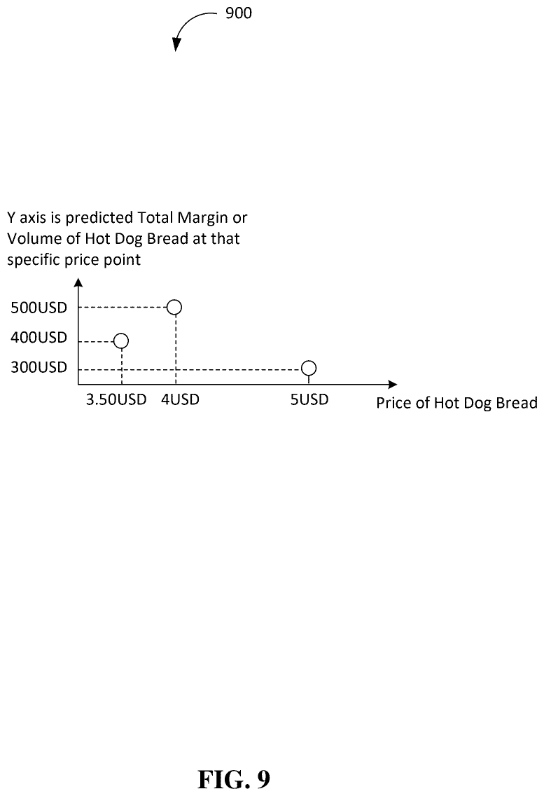

FIG. 9 is a graphical representation 900 of a predictive elasticity of a product corresponding to a plurality of price points of the products, in accordance with an exemplary embodiment. Further, the product may be a hot dog bread. Further, at 3.50 USD a package of the product, the total margin of sales is 400 USD for a number of units of the package. Further, at 4.00 USD a package of the product, the total margin of sales is 500 USD for a number of units of the package. Further, at 5.00 USD a package of the product, the total margin of sales is 300 USD for a number of units of the package.

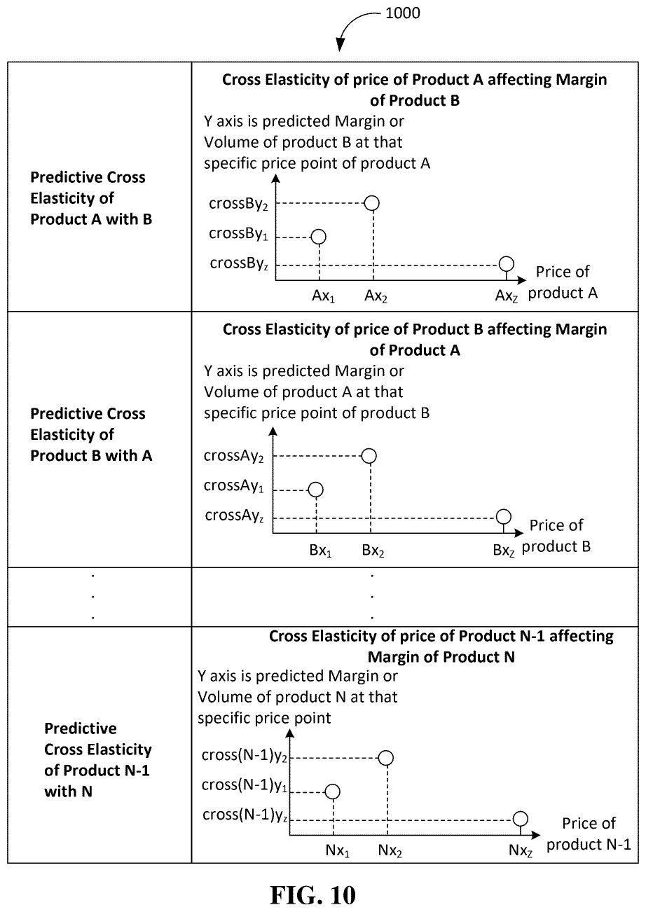

FIG. 10 is a representation 1000 of a predictive cross elasticity of a plurality of related products corresponding to a plurality of price points of the plurality of related products, in accordance with some embodiments.

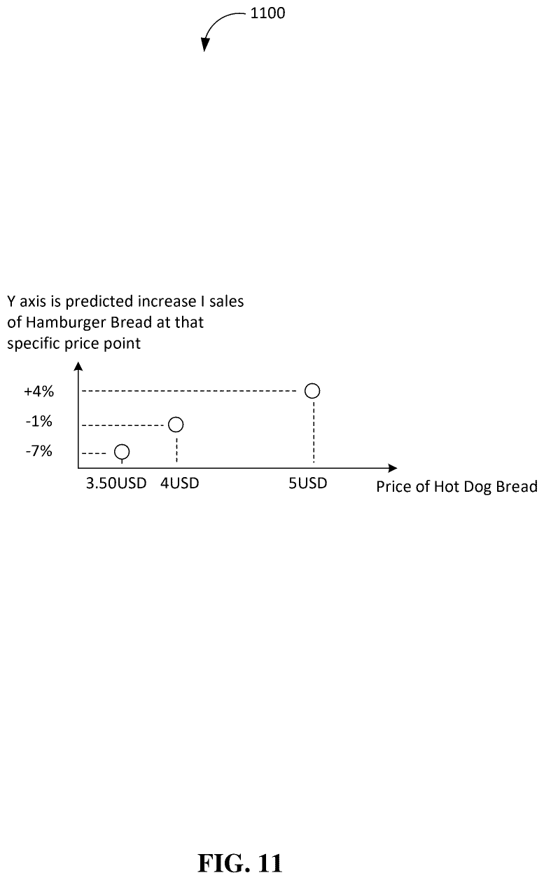

FIG. 11 is a graphical representation 1100 of a predictive cross elasticity of a pair of related products corresponding to a plurality of price points of one of the pair of related products, in accordance with an exemplary embodiment. Further, the pair of related products may include a hot dog bread and a hamburger bread. Further, at 3.50 USD a package of the hot dog bread the number of hamburger bread sales is reduced by 7%. Further, at 4.00 USD a package of hot dog bread the number of hamburger bread sales is reduced by 1%. Further, at 5.00 USD a package of the hot dog bread the number of hamburger bread sales is increased by 4%.

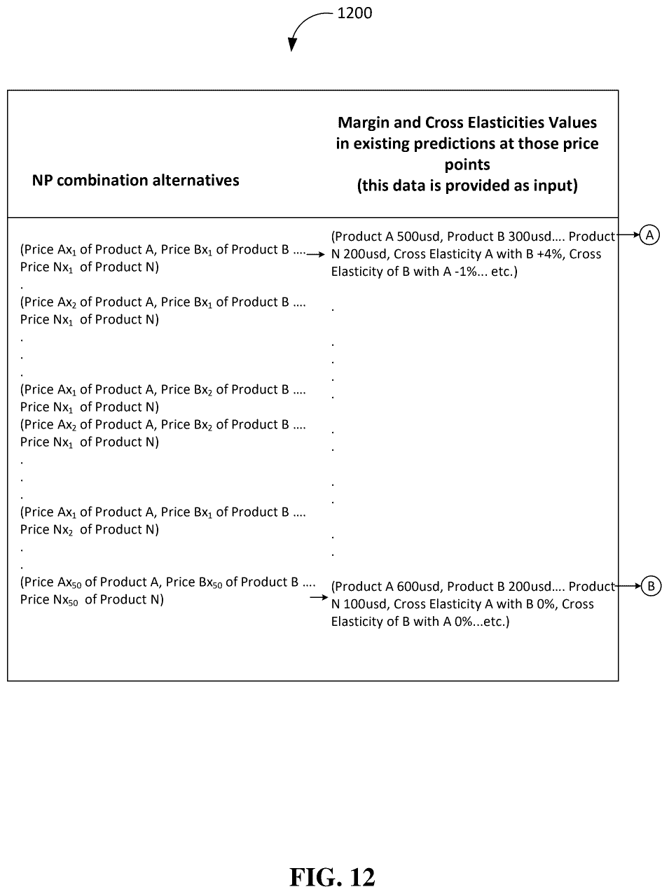

FIG. 12 is a tabular representation 1200 of combination alternatives of a plurality of price points of a plurality of products, margin and cross elasticities value corresponding to the combination alternatives, margin per product with the cross elasticities, and total margin, in accordance with some embodiments. Further, an objective function may be finding a combination of prices that maximizes the total margin. Further, the combination alternatives of the plurality of price points may be associated with 50 or 70 price points.

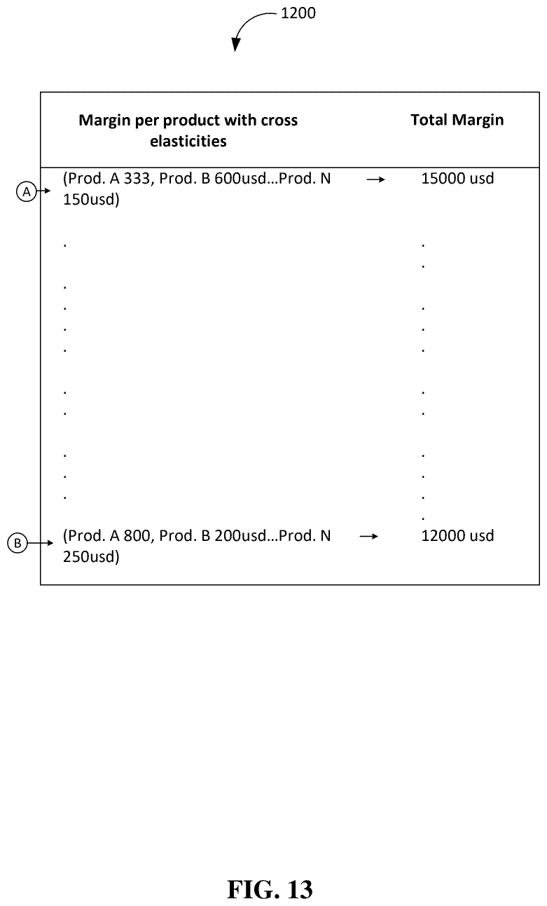

FIG. 13 is a continuation of the tabular representation 1200, in accordance with some embodiments.

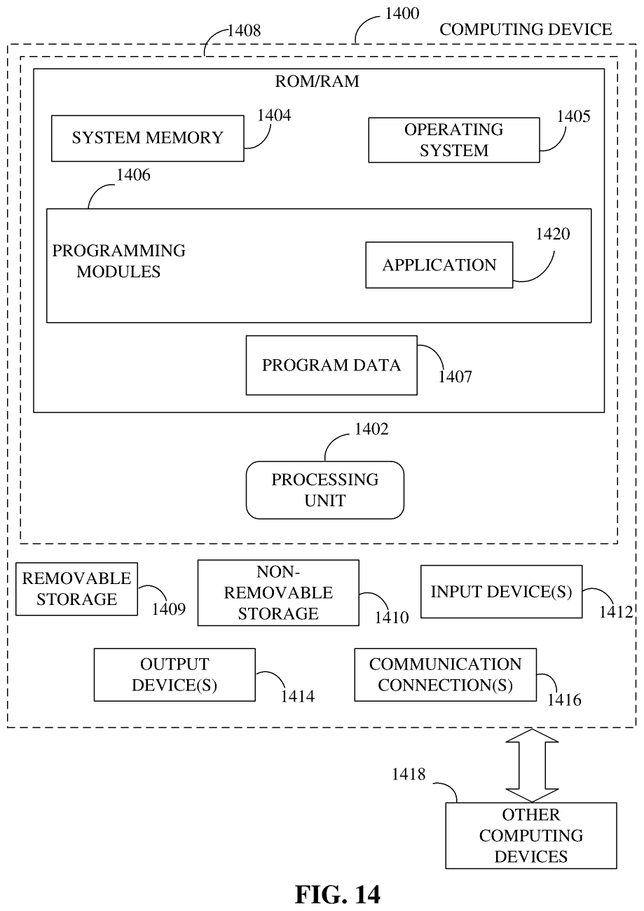

With reference to FIG. 14, a system consistent with an embodiment of the disclosure may include a computing device or cloud service, such as computing device 1400. In a basic configuration, computing device 1400 may include at least one processing unit 1402 and a system memory 1404. Depending on the configuration and type of computing device, system memory 1404 may comprise, but is not limited to, volatile (e.g. random-access memory (RAM)), non-volatile (e.g. read-only memory (ROM)), flash memory, or any combination. System memory 1404 may include operating system 1405, one or more programming modules 1406, and may include a program data 1407. Operating system 1405, for example, may be suitable for controlling computing device 1400's operation. In one embodiment, programming modules 1406 may include machine learning modules. Furthermore, embodiments of the disclosure may be practiced in conjunction with a graphics library, other operating systems, or any other application program and is not limited to any particular application or system. This basic configuration is illustrated in FIG. 14 by those components within a dashed line 1408.

Computing device 1400 may have additional features or functionality. For example, computing device 1400 may also include additional data storage devices (removable and/or non-removable) such as, for example, magnetic disks, optical disks, or tape. Such additional storage is illustrated in FIG. 14 by a removable storage 1409 and a non-removable storage 1410. Computer storage media may include volatile and non-volatile, removable, and non-removable media implemented in any method or technology for storage of information, such as computer-readable instructions, data structures, program modules, or other data. System memory 1404, removable storage 1409, and non-removable storage 1410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1400. Any such computer storage media may be part of device 1400. Computing device 1400 may also have input device(s) 1412 such as a keyboard, a mouse, a pen, a sound input device, a touch input device, a location sensor, a camera, a biometric sensor, etc. Output device(s) 1414 such as a display, speakers, a printer, etc. may also be included. The aforementioned devices are examples and others may be used.

Computing device 1400 may also contain a communication connection 1416 that may allow device 1400 to communicate with other computing devices 1418, such as over a network in a distributed computing environment, for example, an intranet or the Internet. Communication connection 1416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1404, including operating system 1405. While executing on processing unit 1402, programming modules 1406 (e.g., application 1420 such as a media player) may perform processes including, for example, one or more stages of methods, algorithms, systems, applications, servers, databases as described above. The aforementioned process is an example, and processing unit 1402 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

1. A method of determining prices of products, the method comprising:
receiving, using a quantum processing device, a plurality of price elasticity values associated with a plurality of price points, wherein the plurality of price elasticity values corresponds to a plurality of products, wherein a price elasticity value comprises at least one of a predicted volume and a predicted margin corresponding to a price point;
receiving, using the quantum processing device, a plurality of cross-elasticity values associated with a plurality of related product price points, wherein the plurality of cross-clasticity values corresponds to at least one pair of products comprising a target product and a related product, wherein a cross-elasticity value of the target product comprises at least one of a predicted volume and a predicted margin corresponding to a related product price point;
encoding, using the quantum processing device, each of the plurality of price elasticity values and the plurality of cross-elasticity values as a plurality of binary variables;
formulating, using the quantum processing device, an objective function based on all possible combinations of the plurality of price elasticity values and the plurality of cross-elasticity values, wherein the objective function is formulated as a quadratic unconstrained binary optimization (QUBO) problem by modeling a problem of maximizing margin associated with the objective function using quantum integer programming (QIP), wherein the objective function is expressed as a quadratic polynomial of the plurality of binary variables in the QUBO problem, wherein the quantum processing device comprises a quantum annealing device, wherein the QUBO problem is mappable to one or more Ising models, wherein the one or more Ising models is a natural input to the quantum annealing device, wherein the QIP is implemented for exact margin maximization, wherein the implementation of the QIP for the exact margin maximization comprises a depth optimization of a quantum circuit comprised in the quantum annealing device, wherein the objective function is mapped onto the quantum circuit by mapping the plurality of binary variables to qubits;
performing, using the quantum processing device, a quantum optimization of the objective function, wherein the quantum optimizing comprises executing quantum annealing on the quantum annealing device for solving the QUBO, wherein an output state of the quantum processing device is obtained based on the executing of the quantum annealing, wherein the output state comprises a superposition of all possible combinations of the plurality of binary variables; and
determining, using the quantum processing device, an optimal combination of prices corresponding to maximizing at least one of a total volume and a total margin corresponding to sales of the plurality of products based on the quantum optimization, wherein the quantum circuit is configured for creating a superposition of all states, applying an Ising Hamiltonian to the superposition of the states for encoding an optimization problem associated with the objective function, and using a simulator to find an optimized volume for at least one of the plurality of products.

2. The method of claim 1 further comprising encoding, using the quantum processing device, the objective function based on at least one of a spin model and a Hamiltonian, wherein the performing of the quantum optimizing is based on the encoding of the objective function.

3. The method of claim 1, wherein the quantum processing device comprises a fault tolerant quantum computer configured to perform quantum error correction.

4. (canceled)

5. (canceled)

6. A method of determining prices of products, the method comprising:
receiving, using a quantum processing device, a plurality of price elasticity values associated with a plurality of price points, wherein the plurality of price elasticity values corresponds to a plurality of products, wherein a price elasticity value comprises at least one of a predicted volume and a predicted margin corresponding to a price point;
receiving, using the quantum processing device, a plurality of cross-elasticity values associated with a plurality of related product price points, wherein the plurality of cross-elasticity values corresponds to at least one pair of products comprising a target product and a related product, wherein a cross-elasticity value of the target product comprises at least one of a predicted volume and a predicted margin corresponding to a related product price point;
encoding, using the quantum processing device, each of the plurality of price elasticity values and the plurality of cross-elasticity values as a plurality of binary variables;
formulating, using the quantum processing device, an objective function based on all possible combinations of the plurality of price elasticity values and the plurality of cross-elasticity values, wherein the objective function is formulated as a quadratic unconstrained binary optimization (QUBO) problem by modeling a problem of maximizing margin associated with the objective function using quantum integer programming (QIP), wherein the objective function is formulated as a quadratic polynomial of the plurality of binary variables based on the encoding, wherein a plurality of coefficients of the quadratic polynomial is based on at least one of prices, costs, and demand functions of the plurality of products, wherein the objective function is expressed as the quadratic polynomial of the plurality of binary variables in the QUBO problem, wherein the quantum processing device comprises a quantum annealing device, wherein the QUBO problem is mappable to one or more Ising models, wherein the one or more Ising models is a natural input to the quantum annealing device, wherein the QIP is implemented for exact margin maximization, wherein the implementation of the OIP for the exact margin maximization comprises a depth optimization of a quantum circuit comprised in the quantum annealing device, wherein the objective function is mapped onto the quantum circuit by mapping the plurality of binary variables to qubits;
performing, using the quantum processing device, a quantum optimization of the objective function, wherein the quantum optimizing comprises executing quantum annealing on the quantum annealing device for solving the QUBO problem;
obtaining, using the quantum processing device, an output state of the quantum processing device comprising a superposition of all possible combinations of the plurality of binary variables based on the performing of the quantum optimizing, wherein a plurality of amplitudes corresponds to a plurality of values of the quadratic polynomial;
decoding, using the quantum processing device, an optimal combination of the plurality of binary variables based on the output state;
interpreting, using the quantum processing device, the optimal combination of the plurality of binary variables based on the decoding;
translating, using the quantum processing device, the optimal combination of the plurality of binary variables back to a plurality of prices based on the interpreting; and
determining, using the quantum processing device, an optimal combination of prices corresponding to maximizing at least one of a total volume and a total margin corresponding to sales of the plurality of products based on the quantum optimization and the translating, wherein the quantum circuit is configured for creating a superposition of all states, applying an Ising Hamiltonian to the superposition of the states for encoding an optimization problem associated with the objective function, and using a simulator to find an optimized volume for at least one of the plurality of products.

7. (canceled)

8. The method of claim 1, wherein the objective function is formulated based on at least one constraint, wherein the at least one constraint comprises at least one of a demand function, a cost function, and a market condition.

9. The method of claim 1, wherein the objective function comprises a profit equation=(P·Q)−(C·Q)−F, wherein P is a price of a product, wherein Q is a quantity sold at price P, wherein C is a cost of production per unit, wherein F is a fixed operating cost.

10. (canceled)

11. (canceled)

12. A quantum processing system for determining prices of products, the quantum processing system comprising:
a quantum processing device configured for:
receiving a plurality of price elasticity values associated with a plurality of price points, wherein the plurality of price elasticity values corresponds to a plurality of products, wherein a price elasticity value comprises at least one of a predicted volume and a predicted margin corresponding to a price point;
receiving a plurality of cross-elasticity values associated with a plurality of related product price points, wherein the plurality of cross-elasticity values corresponds to at least one pair of products comprising a target product and a related product, wherein a cross-elasticity value of the target product comprises at least one of a predicted volume and a predicted margin corresponding to a related product price point;
encoding each of the plurality of price elasticity values and the plurality of cross-elasticity values as a plurality of binary variables;
formulating an objective function based on all possible combinations of the plurality of price elasticity values and the plurality of cross-elasticity values, wherein the objective function is formulated as a quadratic unconstrained binary optimization (QUBO) problem by modeling a problem of maximizing margin associated with the objective function using quantum integer programming (QIP), wherein the objective function is expressed as a quadratic polynomial of the plurality of binary variables in the QUBO problem, wherein the quantum processing device comprises a quantum annealing device, wherein the QUBO problem is mappable to one or more Ising models, wherein the one or more Ising models is a natural input to the quantum annealing device, wherein the QIP is implemented for exact margin maximization, wherein the implementation of the QIP for the exact margin maximization comprises a depth optimization of a quantum circuit comprised in the quantum annealing device, wherein the objective function is mapped onto the quantum circuit by mapping the plurality of binary variables to qubits;
performing a quantum optimization of the objective function, wherein the quantum optimizing comprises executing quantum annealing on the quantum annealing device for solving the QUBO problem, wherein an output state of the quantum processing device is obtained based on the executing of the quantum annealing, wherein the output state comprises a superposition of all possible combinations of the plurality of binary variables; and
determining an optimal combination of prices corresponding to maximizing at least one of a total volume and a total margin corresponding to sales of the plurality of products based on the quantum optimization, wherein the quantum circuit is configured for creating a superposition of all states, applying an Ising Hamiltonian to the superposition of the states for encoding an optimization problem associated with the objective function, and using a simulator to find an optimized volume for at least one of the plurality of products.

13. The quantum processing system of claim 12, wherein the quantum processing device is further configured for encoding the objective function based on at least one of a spin model and a Hamiltonian, wherein the performing of the quantum optimizing is based on the encoding of the objective function.

14. The quantum processing system of claim 12, wherein the quantum processing device comprises a fault tolerant quantum computer configured to perform quantum error correction.

15. (canceled)

16. The quantum processing system of claim 15, wherein the objective function is formulated as the quadratic polynomial of the plurality of binary variables based on the encoding, wherein a plurality of coefficients of the quadratic polynomial is based on at least one of prices, costs, and demand functions of the plurality of products.

17. The quantum processing system of claim 16, wherein the quantum processing device is further configured for:
obtaining the output state of the quantum processing device comprising a superposition of all possible combinations of the plurality of binary variables based on the performing of the quantum optimizing, wherein a plurality of amplitudes corresponds to a plurality of values of the quadratic polynomial;
decoding an optimal combination of the plurality of binary variables based on the output state;
interpreting the optimal combination of the plurality of binary variables based on the decoding; and
translating the optimal combination of the plurality of binary variables back to a plurality of prices based on the interpreting, wherein the determining of the optimal combination of prices is based on the translating.

18. (canceled)

19. The quantum processing system of claim 12, wherein the objective function is formulated based on at least one constraint, wherein the at least one constraint comprises at least one of a demand function, a cost function, and a market condition.

20. The quantum processing system of claim 12, wherein the objective function comprises a profit equation=(P·Q)−(C·Q)−F, wherein P is a price of a product, wherein Q is a quantity sold at price P, wherein C is a cost of production per unit, wherein F is a fixed operating cost.
